(19) United States
(12) Patent Application Publication
(10) Pub. No.: US 2022/0191396 A1
(43) Pub. Date: Jun. 16, 2022

(54) CONTROL APPARATUS, PHOTOGRAPHING SYSTEM, MOVABLE OBJECT, CONTROL METHOD, AND PROGRAM

(71) Applicant: SZ DJI TECHNOLOGY CO., LTD., Shenzhen (CN)

(72) Inventors: Kenichi HONJO, Shenzhen (CN); Tomonaga YASUDA, Shenzhen (CN)

(73) Assignee: SZ DJI TECHNOLOGY CO., LTD., Shenzhen (CN)

(21) Appl. No.: 17/562,887

(22) Filed: Dec. 27, 2021

Related U.S. Application Data
(63) Continuation of application No. PCT/CN2020/122780, filed on Oct. 22, 2020.

(30) Foreign Application Priority Data
Nov. 25, 2019 (JP) 2019-212081

(51) Int. Cl. H04N 5/232; G02B 27/64; G03B 5/02

(52) U.S. Cl. CPC H04N 5/23274; H04N 5/23287; G03B 2205/0007; G03B 5/02; G02B 27/646

(57) ABSTRACT

A photographing apparatus that supported by a supporting assembly generates vibration when performing shake correction, the vibration sometimes affects the attitude control of the supporting assembly over the photographing apparatus. The present disclosure provides a control apparatus for controlling a photographing system including a photographing apparatus including an optical system, an image sensor, and a driving assembly, where when the photographing apparatus performs a shake correction, the driving assembly moves at least one of the optical system or the image sensor along a direction intersecting an optical axis of the optical system, and a supporting assembly rotatably supporting the photographing apparatus, the control apparatus including: a circuit configured to: obtain, based on a vibration signal indicating a vibration of the photographing apparatus, a driving signal of the driving assembly configured to perform the shake correction, and control the supporting assembly based on the vibration signal and the driving signal.

### RELATED APPLICATIONS

This application is a continuation application of PCT application No. PCT/CN2020/122780, filed on Oct. 22, 2020, which claims the priority of Japanese patent application No. JP 2019-212081, filed on Nov. 25, 2019, and the content of which are incorporated herein by reference in their entirety.

### TECHNICAL FIELD

The present disclosure relates to a control apparatus, a photographing system, a movable object, a control method, and a program.

### BACKGROUND

The patent reference 1: “Japan Patent Gazette No. 6331180” discloses: a shake correction of a photographing apparatus is controlled based on a rotation speed of a motor or a current input to the motor, the motor is configured to rotate a propeller(s) of a flying body carrying the photographing apparatus.

### BRIEF SUMMARY

A photographing apparatus supported by a supporting assembly may generate vibration due to the performance of shake corrections, however, the vibration of the photographing apparatus sometimes may affect the attitude control of the photographing apparatus performed by the supporting assembly. The present disclosure provides a method and a system to minimize a vibration effect on an attitude control of the photographing apparatus.

In some exemplary embodiments, a control apparatus for controlling a photographing system is provided, the photographing system includes: a photographing apparatus including an optical system, an image sensor, and a driving assembly, where when the photographing apparatus performs a shake correction, the driving assembly moves at least one of the optical system or the image sensor along a direction intersecting an optical axis of the optical system, and a supporting assembly rotatably supporting the photographing apparatus, the control apparatus includes: a circuit configured to: obtain, based on a vibration signal indicating a vibration of the photographing apparatus, a driving signal of the driving assembly configured to perform the shake correction, and control the supporting assembly based on the vibration signal and the driving signal.

In some exemplary embodiments, a movable object is provided, including: a photographing system, including: a photographing apparatus including: an optical system, an image sensor, and a driving assembly, where when the photographing apparatus performs a shake correction, the driving assembly moves at least one of the optical system or the image sensor along a direction intersecting an optical axis of the optical system; a supporting assembly rotatably supporting the photographing apparatus; and a control apparatus to control the photographing system, including: a circuit configured to: obtain, based on a vibration signal indicating a vibration of the photographing apparatus, a driving signal of the driving assembly configured to perform the shake correction, and control the supporting assembly based on the vibration signal and the driving signal.

In some exemplary embodiments, a control method for controlling a photographing system is provided, where the photographing system includes: a photographing apparatus including an optical system, an image sensor, and a driving assembly, where when the photographing apparatus performs a shake correction, the driving assembly moves at least one of the optical system or the image sensor along a direction intersecting an optical axis of the optical system, and a supporting assembly rotatably supporting the photographing apparatus, the control method including: obtaining, based on a vibration signal indicating a vibration of the photographing apparatus, a driving signal of the driving assembly configured to perform the shake correction, and controlling the supporting assembly based on the vibration signal and the driving signal.

In addition, the above summary does not enumerate all the essential features of the present disclosure. In addition, sub-combinations of the feature groups should fall within the scope of protections of the present disclosure.

### BRIEF DESCRIPTION OF THE DRAWINGS

To clearly describe the technical solutions in some exemplary embodiments of the present disclosure, the following briefly describes the accompanying drawings for describing the exemplary embodiments. Evidently, the accompanying drawings in the following description show merely some exemplary embodiments of the present disclosure, and a person of ordinary skill in the art may still derive other drawings from these accompanying drawings without creative efforts.

FIG. 1 is a perspective view of a photographing system according to some exemplary embodiments of the present disclosure;

FIG. 2 is a functional block diagram of a photographing system according to some exemplary embodiments of the present disclosure;

FIG. 3 is a diagram illustrating a reaction force applied to a pitch axis of a universal joint according to some exemplary embodiments of the present disclosure;

FIG. 4 is a diagram illustrating a reaction force applied to a yaw axis of a universal joint according to some exemplary embodiments of the present disclosure;

FIG. 5A is a diagram illustrating a reaction force applied to a roll axis of a universal joint according to some exemplary embodiments of the present disclosure;

FIG. 5B is a diagram illustrating a reaction force applied to a roll axis of a universal joint according to some exemplary embodiments of the present disclosure;

FIG. 6 is a diagram illustrating a thrust of a lens for image stabilization in a Y direction, a reaction force of a universal joint in a pitch direction against the thrust, and the force that should be applied in a pitch direction of the universal joint according to some exemplary embodiments of the present disclosure;

FIG. 7 is a diagram illustrating a thrust of a lens for image stabilization in a Y direction and a X direction, a reaction force of a universal joint in a roll direction against the thrust, and the force that should be applied in a roll direction of the universal joint according to some exemplary embodiments of the present disclosure;

FIG. 8 is a flowchart illustrating a control procedure of a universal joint when performing image stabilization according to some exemplary embodiments of the present disclosure;

FIG. 9 is an unmanned aerial vehicle and a remotely operated device according to some exemplary embodiments of the present disclosure; and

FIG. 10 is a diagram showing a hardware composition according to some exemplary embodiments of the present disclosure.

### REFERENCE NUMERALS

10 UAV
20 UAV main body
50 Universal joint
60 Photographing device
100 Photographing apparatus
102 Photographing unit
110 Photographing control unit
120 Image sensor
130 Storage medium
150 Image sensor driving unit
152 Position sensor
200 Lens unit
210 Focus lens
211 Zoom lens
212, 213 Lens driving unit
214, 215 Position sensor
220 Lens control unit
231 Lens
233 Lens driving unit
235 Position sensor
250 Vibration sensor
400 Handheld unit
410 Supporting unit
412 Rod unit
414 Rod unit
420 Handheld unit
450 Display device
510 Universal joint control unit
512 Yaw axis driver
514 Yaw axis driving unit
516 Yaw axis rotation assembly
522 Pitch axis driver
524 Pitch axis driving unit
526 Pitch axis rotation assembly
532 Roll axis driver
534 Roll axis driving unit
536 Roll axis rotation assembly
300 Remote operation device
600 Main control unit
610 Storage medium
1000 Photographing system
1200 Computer
1210 Host controller
1212 CPU
1214 RAM
1220 Input/output controller
1222 Communications interface
1230 ROM

### DETAILED DESCRIPTION

The following describes the present disclosure with reference to some exemplary embodiments. However, the exemplary embodiments do not limit the claims. In addition, all feature combinations described in the exemplary embodiments are not necessarily mandatory for solutions of the present disclosure. For a person of ordinary skill in the art, obviously various modifications or improvements may be made to the exemplary embodiments. Obviously, from the descriptions of the claims, any manner of such variations or improvements should be included in the technical scope of the present disclosure.

The claims, the specification, the accompanying drawings, and the abstract contain materials which may be subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

It should be noted that, when a component is described as “fixed” to another component, the component may be directly located on another component, or an intermediate component may exist therebetween. When a component is considered as “connected” to another component, the component may be directly connected to another element, or an intermediate element may exist therebetween.

Unless otherwise defined, meanings of all technical and scientific terms used in the present disclosure are the same as those generally understood by persons skilled in the art of the present disclosure. The terms used in the present disclosure of the present disclosure herein are used only to describe specific embodiments, and not intended to limit the present disclosure. The term “and/or” used in the present disclosure includes any or all possible combinations of one or more associated listed items.

The following describes in detail some implementations of the present disclosure with reference to the accompanying drawings. Under a condition that no conflict occurs, the following embodiments and features in the embodiments may be mutually combined. The following description provides specific application scenarios and requirements of the present application in order to enable those skilled in the art to make and use the present application. Various modifications to the disclosed embodiments will be apparent to those skilled in the art. The general principles defined herein may be applied to other embodiments and applications without departing from the spirit and scope of the disclosure. Therefore, the present disclosure is not limited to the embodiments shown, but the broadest scope consistent with the claims.

The terminology used herein is for the purpose of describing particular exemplary embodiments only and is not intended to be limiting. When used in this disclosure, the terms “comprise”, “comprising”, “include” and/or “including” refer to the presence of stated features, integers, steps, operations, elements, and/or components, but do not preclude the presence or addition of one or more other features, integers, steps, operations, elements, components, and/or groups thereof. As used in this disclosure, the term “A on B” means that A is directly adjacent to B (from above or below), and may also mean that A is indirectly adjacent to B (i.e., there is some element between A and B); the term “A in B” means that A is all in B, or it may also mean that A is partially in B.

In view of the following description, these and other features of the present disclosure, as well as operations and functions of related elements of the structure, and the economic efficiency of the combination and manufacture of the components, may be significantly improved. All of these form part of the present disclosure with reference to the drawings. However, it should be clearly understood that the drawings are only for the purpose of illustration and description, and are not intended to limit the scope of the present disclosure. It is also understood that the drawings are not drawn to scale.

In some embodiments, numbers expressing quantities or properties used to describe or define the embodiments of the present application should be understood as being modified by the terms “about”, “generally”, “approximate,” or “substantially” in some instances. For example, “about”, “generally”, “approximately” or “substantially” may mean a ±20% change in the described value unless otherwise stated. Accordingly, in some embodiments, the numerical parameters set forth in the written description and the appended claims are approximations, which may vary depending upon the desired properties sought to be obtained in a particular embodiment. In some embodiments, numerical parameters should be interpreted in accordance with the value of the parameters and by applying ordinary rounding techniques. Although a number of embodiments of the present application provide a broad range of numerical ranges and parameters that are approximations, the values in the specific examples are as accurate as possible.

Each of the patents, patent applications, patent application publications, and other materials, such as articles, books, instructions, publications, documents, products, etc., cited herein are hereby incorporated by reference, which are applicable to all contents used for all purposes, except for any history of prosecution documents associated therewith, or any identical prosecution document history, which may be inconsistent or conflicting with this document, or any such subject matter that may have a restrictive effect on the broadest scope of the claims associated with this document now or later. For example, if there is any inconsistent or conflicting in descriptions, definitions, and/or use of a term associated with this document and descriptions, definitions, and/or use of the term associated with any materials, the term in this document shall prevail.

It should be understood that the embodiments of the application disclosed herein are merely described to illustrate the principles of the embodiments of the application. Other modified embodiments are also within the scope of this application. Therefore, the embodiments disclosed herein are by way of example only and not limitations. Those skilled in the art may adopt alternative configurations to implement the technical solution in this application in accordance with the embodiments of the present application. Therefore, the embodiments of the present application are not limited to those embodiments that have been precisely described in this disclosure.

The following describes the present disclosure by using implementations of the present disclosure. However, the following implementations do not limit the claims. In addition, all feature combinations described in the implementations are not necessarily mandatory for solutions of the present disclosure. For a person of ordinary skill in the art, various variations or improvements may be made to the following implementations. Obviously, from the descriptions of the claims, any manner of such variations or improvements may be included in the technical scope of the present disclosure.

Various implementations of the present disclosure may be described with reference to flowcharts and block diagrams. Herein, a block may indicate (1) a stage of a process for performing an operation or (2) a “unit” of an apparatus having a function of performing an operation. The specific stage and “unit” may be implemented by a programmable circuit and/or a processor. A dedicated circuit may include a digital and/or analog hardware circuit and may include integrated circuit (IC) and/or a discrete circuit. The programmable circuit may include a reconfigurable hardware circuit. The reconfigurable hardware circuit may include logic AND, logic OR, logic XOR, logic NAND, logic NOR, and other logic operations, and storage elements such as a trigger, a register, a field programmable gate array (FPGA), a programmable logic array (PLA).

A computer-readable medium may include any tangible device that may store at least one instruction executable by an appropriate device. As a result, the computer-readable medium storing at least one instruction may include a product including at least one instruction executable to create means for performing operations specified by the flowcharts or block diagrams. An example of the computer-readable medium may include but not limited to an electronic storage medium, a magnetic storage medium, an optical storage medium, an electromagnetic storage medium, a semiconductor storage medium, and the like. A specific example of the computer-readable medium may include a Floppy™ disk, a diskette, a hard disk, a random access memory (RAM), a read-only memory (ROM), an erasable programmable ROM (EPROM or flash memory), an electrically erasable programmable ROM (EEPROM), a static RAM (SRAM), a compact disc ROM (CD-ROM), a digital versatile disc (DVD), a Blu-ray (registered trademark) disc, a memory stick, an integrated circuit card, or the like.

At least one computer-readable instruction may include any one of source code or object code described by any combination of one or more programming languages. The source code or the object code may include a conventional program-mode programming language. The conventional program-mode programming language may be an object-oriented programming language and the “C” programming language or a similar programming language, for example, an assembly instruction, an instruction set architecture (ISA) instruction, a machine instruction, a machine-related instruction, a microcode, a firmware instruction, status setting data, or Smalltalk™, JAVA™, or C++. The computer-readable instruction may be provided locally or through a local area network (LAN), a wide area network (WAN) such as the Internet to a processor or a programmable circuit of a general-purpose computer, a dedicated computer, or another programmable data processing apparatus. The processor or the programmable circuit may execute the at least one computer readable instruction to create a means for performing the operations specified by the flowcharts or the block diagrams. A non-limiting example of the processor may include a computer processor, a processing unit, a microprocessor, a digital signal processor, a control apparatus, a micro-control apparatus, or the like.

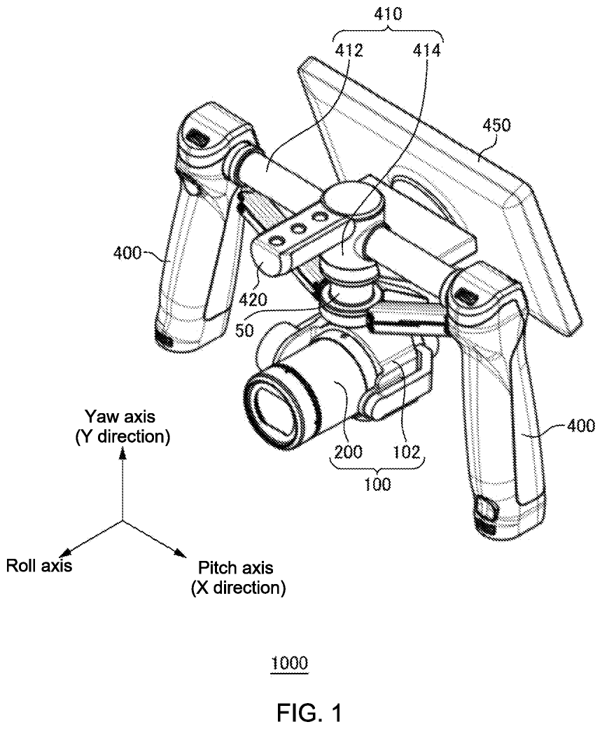

FIG. 1 is a perspective view of a photographing system 1000 according to some exemplary embodiments of the present disclosure. The photographing system 1000 may include a universal joint 50, a photographing apparatus 100, a supporting unit 410, a pair of handheld units 400, a handheld unit 420, and a display device 450.

The photographing apparatus 100 may be an image camera for photographing a to-be-photographed object in a desired imaging range. The universal joint 50 may rotatably support the photographing apparatus 100. The universal joint 50 may support the photographing apparatus 100 by adjusting its attitude. The universal joint 50 may be a non-limiting example of a supporting assembly. In some exemplary embodiments according to the present disclosure, the universal joint 50 may use an actuator to support the photographing apparatus 100 to rotate around a pitch axis. The universal joint 50 may use the actuator to further support the photographing apparatus 100 to rotate around a roll axis and a yaw axis, respectively. The universal joint 50 may change the attitude of the photographing apparatus 100 by causing the photographing apparatus 100 to rotate around at least one of the yaw axis, the pitch axis, or the roll axis.

The supporting unit 410 may detachably support the universal joint 50. The supporting unit 410 may be a T-shaped unit, including a rod unit 412 extending in a direction of a pitch axis, and a rod unit 414 extending from the central portion of the rod unit 412 toward a direction of the yaw axis. The pair of handheld units 400 may be rotatably mounted on the supporting unit 410. The pair of handheld units 400 may hold the universal joint 500 in the middle, and may be mounted at both ends of the rod unit 412. The pair of handheld units 400 may be rotatably mounted on the supporting unit 410. The pair of handheld units 400 may be detachably mounted on the supporting unit 410. The universal joint 50 may be detachably mounted at one end of the rod unit 414. The handheld unit 420 may extend along a direction of a roll axis, and may be mounted on the other end of the rod unit 414.

The display device 450 may be located on the rod member 414. The display device 450 may be a touch screen display. The display device 450 may be mounted on the rod unit 414 opposite to a side of the photographing apparatus 100 including a lens unit 200. The display device 450 may be mounted on the rod unit 414, which is also on the back side of the photographing apparatus 100, opposite to the front side of the photographing apparatus 100 including the lens unit 200. The display device 450 may be detachably mounted on the supporting unit 410. The photographing system 1000 may be usable when the display device 450 is detached from the supporting unit 410. The display device 450 may be mounted on the supporting unit 410 such that the angle of the display surface may be adjustable. The display device 450 may be mounted on the supporting unit 410 and rotatable around the pitch axis.

The supporting unit 410 and the display device 450 are non-limiting examples of a mounting unit mounted on the supporting unit 410. In addition, in some exemplary embodiments, the display device 450 may be mounted on the supporting unit 410 independently of the photographing apparatus 100. However, the display device 450 may be configured to be part of the photographing apparatus 100. The display device 450 may be supported by the supporting unit 410 via the photographing apparatus 100. In some exemplary embodiments, the display device 450 may be integrally located on the photographing apparatus 100. In some exemplary embodiments, the display device 450 may be located on the photographing apparatus 100 such that the angle of the display surface is adjustable with respect to the photographing apparatus 100.

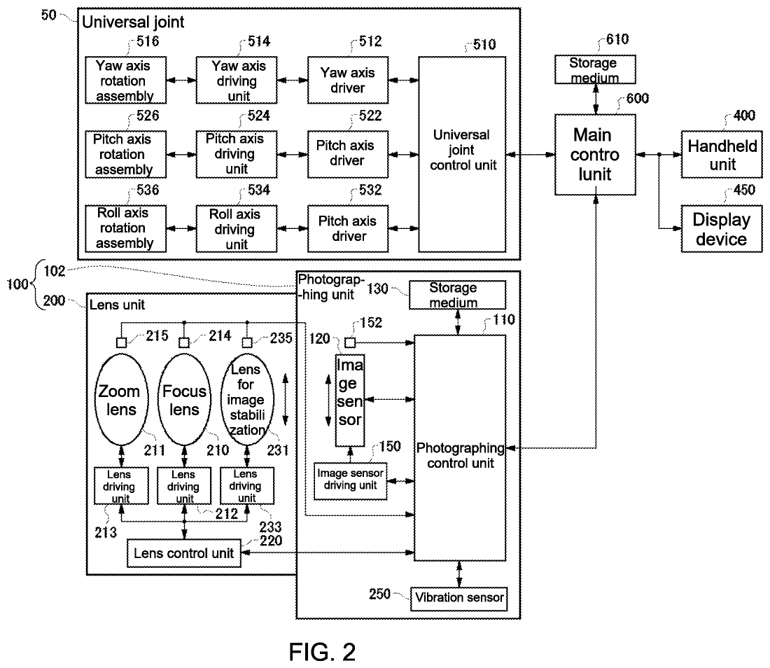

FIG. 2 is a functional block diagram of a photographing system 1000 according to some exemplary embodiments of the present disclosure. The photographing system 1000 may include a universal joint 50, a photographing apparatus 100, a main control unit 600, a storage medium 610, a pair of handheld unit 400, and a display device 450.

The display device 450 may display an image photographed by the photographing apparatus 100. The display device 450 may display a setting screen for setting various action conditions of the universal joint 50 and the photographing apparatus 100. The display device 450 may be a touch screen display, a user may control the universal joint 50 and the photographing apparatus 100 via the display device 450.

The main control unit 600 may control the whole photographing system 1000. The main control unit 600 may include a microprocessor such as a CPU or an MPU, a microcontroller such as an MCU, or the like. The storage medium 610 may store a program code such as the program code required for the main control unit 600 to control the universal joint 50, the photographing apparatus 100, and the pair of handheld units 400. The storage medium 610 may be a computer readable medium, and may include at least one of: an SRAM, a DRAM, an EPROM, an EEPROM, or a USB memory. The storage medium 610 may be mounted on the supporting unit 410. The storage medium 610 may be detachable from the supporting unit 410.

The universal joint 50 may include a universal joint control unit 510, a yaw axis driver 512, a pitch axis driver 522, a roll axis driver 532, a yaw axis driving unit 514, a pitch axis driving unit 524, a roll axis driving unit 534, a yaw axis rotation assembly 516, a pitch axis rotation assembly 526, and a roll axis rotation assembly 536.

The yaw axis rotation assembly 516 may rotate the photographing apparatus 100 around the yaw axis. The pitch axis rotation assembly 526 may rotate the photographing apparatus 100 around the pitch axis. The roll axis rotation assembly 536 may rotate the photographing apparatus 100 around the roll axis. The universal joint control unit 510 may output, based on a driving signal of the universal joint 50 from the main control unit 600, the driving signal to the yaw axis driver 512, the pitch axis driver 522, and the roll axis driver 532 that indicates respective driving amounts. The yaw axis driver 512, the pitch axis driver 522, and the roll axis driver 532 may drive the yaw axis driving unit 514, the pitch axis driving unit 524, and the roll axis driving unit 534 according to the driving signal indicating the driving amount. The yaw axis rotation assembly 516, the roll axis rotation assembly 536, and the roll axis rotation assembly 536 may rotate respectively by the drive of the yaw axis driving unit 514, the pitch axis driving unit 524 and the roll axis driving unit 534, and change the attitude of the photographing apparatus 100.

The photographing apparatus 100 may include a photographing unit 102 and a lens unit 200. The photographing unit 102 may include an image sensor 120, a photographing control unit 110, and a storage medium 130. The image sensor 120 may include a Charge-coupled Device (CCD) or a Complementary Metal Oxide Semiconductor (CMOS). The image sensor 120 may output an image data of an optical image photographed by a zoom lens 211 and a focus lens 210 to the photographing control unit 110.

The photographing control unit 110 may include a microprocessor such as a CPU or an MPU, and a microcontroller such as an MCU, or the like. The storage medium 130 may be a computer readable recording medium, and may include at least one of: an SRAM, a DRAM, an EPROM, an EEPROM, or a USB memory. The storage medium 130 may store a program code such as the program code required for the photographing control unit 110 to control the image sensor 120. The storage medium 130 may be located inside a housing of the photographing apparatus 100. The storage medium 130 may be detachable from the housing of the photographing apparatus 100.

The lens unit 200 may include the focus lens 210, the zoom lens 211, a lens driving unit 212, a lens driving unit 213, and a lens control unit 220. The focus lens 210 and the zoom lens 211 may include at least one lens. At least part or all the focus lens 210 and the zoom lens 211 may be configured to move along the optical axis. The lens unit 200 may include an interchangeable lens that is detachable from the photographing unit 102. The lens driving unit 212 may move part of or all the focus lens 210 along the optical axis via a mechanical part such as a cam ring, a guide shaft, or the like. The lens driving unit 213 may move part of or all the zoom lens 211 along the optical axis via a mechanical part such as a cam ring, a guide shaft, or the like. The lens control unit 220 may drive, based on a lens control instruction from the photographing unit 102, at least one of the lens driving unit 212, or the lens driving unit 213. The lens control unit 220 may move, through the mechanical part, at least one of the focus lens 210 or the zoom lens 211 along the direction of the optical axis, so as to execute at least one of a zooming operation or a focusing operation. The non-limiting exemplary lens control instruction may be a zoom control instruction or a focus control instruction.

The lens unit 200 may further include a position sensor 214, and a position sensor 215. The position sensor 214 may detect a position of the focus lens 210. The position sensor 214 may detect a current focus position. The position sensor 215 may detect a position of the zoom lens 211. The position sensor 215 may detect a current zoom position of the zoom lens 211.

The lens unit 200 may include an optical image stabilization (OIS) mechanism. Specifically, the lens unit 200 may include a lens 231 for image stabilization, a lens driving unit 233, and a position sensor 235 for the image stabilization. In addition, the photographing unit 102 may include a vibration sensor 250. The vibration sensor 250 may output a vibration signal indicating the vibration of the photographing apparatus 100. The vibration sensor 250 may be a gyroscope sensor detecting the vibration of the photographing apparatus 100. The vibration sensor 250 may be an acceleration sensor detecting the vibration of the photographing apparatus 100. The gyroscope sensor may detect, for example, an angular shaking or a rotational shaking. The acceleration sensor may detect, for example, a displacement shaking in an X direction and a Y direction. The gyroscope sensor may further decompose the angle and rotation into X-directional components and Y-directional components, respectively. The acceleration sensor may further decompose the displacement shaking in the X direction and the Y direction into the angular shaking and the rotational shaking. The vibration sensor 250 may be a combination of the acceleration sensor and the gyroscope sensor.

The lens driving unit 233 may move the lens 231 along a direction perpendicular to the optical axis to perform an image stabilization. The lens driving unit 233 may include a motor that drives the lens 231 along the X direction, and a motor that drives the lens 231 along the Y direction. The motor may be a stepper motor or a voice coil motor.

The photographing control unit 110 may generate, based on the vibration signal from the vibration sensor 250, a driving signal to the lens driving unit 233 for performing image stabilization. The lens driving unit 233 may move, based on the driving signal, the lens 231 along a direction perpendicular to the optical axis. The lens driving unit 233 may move, based on the driving signal, the lens 231 along the X direction and the Y direction, which are both perpendicular to the optical axis. The lens driving unit 233 may move, based on the vibration signal from the vibration sensor 250, the lens 231 along a direction that is perpendicular to the optical axis and reduces the vibration effect of the photographing apparatus 100.

The driving signal may indicate the amount of movement that the lens 231 is moved along the X direction and the Y direction. The driving signal may indicate the driving amount of the motor that moves the lens 231 along the X direction, and the driving amount of the motor that moves the lens 231 along the Y direction. The driving signal may indicate a current value input to each motor.

The position sensor 235 may detect a position of the lens 231. The position sensor 235 may detect a position of the lens 231 perpendicular to the optical axis. The position sensor 235 may detect a position of the lens 231 perpendicular to the X direction and the Y direction of the optical axis.

The lens unit 200 may be a non-limiting example of an image stabilization apparatus. The lens unit 200 may obtain the vibration signal indicating the vibration from the vibration sensor 250, and the lens 231 may vibrate, based on the vibration signal and via the lens driving unit 233, along at least one of the X direction or the Y direction intersecting the optical axis, so as to stabilize an image. The image sensor 120 may photograph an image photographed by at least one of: the zoom lens 211, the focus lens 210, or the lens 231.

The photographing unit 102 may further include a body image stabilization (BIS) mechanism. Specifically, the photographing unit 102 may further include an image sensor driving unit 150, and a position sensor 152. The image sensor driving unit 150 may move the image sensor 120 along a direction intersecting the optical axis. The image sensor driving unit 150 may move the image sensor 120 along a direction perpendicular to the optical axis. The image sensor driving unit 150 may move the image sensor 120 along at least one of the X direction or the Y direction perpendicular to the optical axis. The image sensor driving unit 150 may include a first motor that drives the image sensor 120 along the X direction, and a second motor that drives the image sensor 120 along the Y direction. The first motor and the second motor may be a stepper motor or a voice coil motor, respectively. The position sensor 152 may detect a position of the image sensor 120. The position sensor 152 may detect a position of the image sensor 120 perpendicular to the optical axis. The photographing control unit 110 may obtain the vibration signal indicating the vibration of the photographing apparatus 100 from the vibration sensor 250, and the image sensor 120 may vibrate, based on the vibration signal and via the image sensor driving unit 150, along a direction intersecting the optical axis, so as to stabilize an image.

The photographing control unit 110 may generate, based on the vibration signal from the vibration sensor 250, the driving signal to the image sensor driving unit 150 to stabilize an image. The image sensor driving unit 150 may move, based on the driving signal, the image sensor 120 along a direction perpendicular to the optical axis. The image sensor driving unit 150 may move, based on the driving signal, the image sensor 120 along the X direction and/or the Y direction perpendicular to the optical axis. The image sensor driving unit 150 may move, based on the vibration signal from the vibration sensor 250, the image sensor 120 along a direction that is perpendicular to the optical axis and reduces the vibration effect of the photographing apparatus 100.

The driving signal may indicate an amount of movement that moves the image sensor 120 along the X direction and the Y direction. The driving signal may indicate a driving amount of the motor that moves the image sensor 120 along the X direction, and a driving amount of the motor that moves the image sensor 120 along the Y direction. The driving signal may indicate a current value(s) being input to each motor.

The photographing apparatus 100 may include at least one of OIS mechanism or BIS mechanism. The image sensor driving unit 150 or the lens driving unit 233 may be a non-limiting example of the driving assembly.

In the photographing system 1000, the universal joint 50 may control the attitude of the photographing apparatus 100. The universal joint 50 may control, via the yaw axis driving unit 514, the pitch axis driving unit 524, and the roll axis driving unit 534, the yaw axis rotation assembly 516, the roll axis rotation assembly 526, and the roll axis rotation assembly 536, respectively, so as to maintain a preset attitude of the photographing apparatus. However, sometimes the universal joint 50 may not be able to completely counteract the vibration of the photographing apparatus 100. The universal joint 50 may counteract the low frequency vibration of the photographing apparatus 100. However, the universal joint 50 may not be able to counteract the high frequency vibration of the photographing apparatus 100. When the photographing apparatus 100 and the universal joint 50 are mounted on a movable object such as a flying object, the photographing apparatus 100 may experience high frequency vibration.

Therefore, the photographing apparatus 100 may counteract, through an image stabilization mechanism such as the OIS or the BIS, the high frequency vibration that the universal joint 50 is unable to counteract. However, as the image stabilization is being performed, the lens for image stabilization 231, and/or the image sensor 120 for the image stabilization may move, and therefore generating a reaction force of a thrust, and the reaction force of the thrust may be applied to the universal joint 50 that supports the photographing apparatus 100. Because of the reaction force, sometimes the universal joint 50 may not be able to properly control the attitude of the photographing apparatus 100. That is, because of the image stabilization performed by the photographing apparatus 100, the universal joint 50 may not be able to appropriately control the attitude of the photographing apparatus 100, and the image photographed by the photographing apparatus 100 may be blurred due to the improperly controlled attitude.

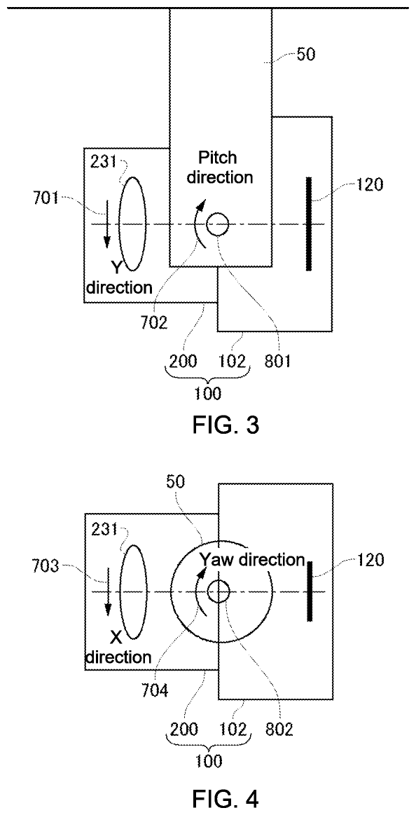

As shown in FIG. 3, a thrust 701 may be generated due to the movement of the lens 231 along the Y direction, and a reaction force 702 against the thrust may be applied to a pitch axis 801 of the universal joint 50. As shown in FIG. 4, a thrust 703 may be generated due to the movement of the lens 231 along the X direction, and a reaction force 704 against the thrust may be applied to a yaw axis 802 of the universal joint 50.

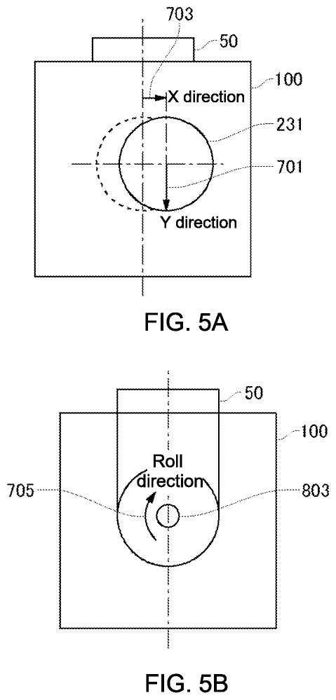

In addition, as shown in FIG. 5A, the center of gravity of the photographing apparatus 100 may be shifted relative to the universal joint 50 due to the movement of the lens 231 along the X direction and the Y direction, as shown in FIG. 5B, a reaction force 705 that against the thrust 703 of the movement of the lens 231 along the X direction and against the thrust 701 of the movement along the Y direction may be applied to a roll axis 803 of the universal joint 50.

Because the reaction force is applied to each axis of the universal joint 50, the universal joint 50 may not be able to appropriately control the attitude of the photographing apparatus 100 in some cases. Because of the reaction force, sometimes the universal joint 50 may not be able to maintain the preset attitude of the photographing apparatus 100.

Therefore, in order to reduce the reaction forces, the main control unit 600 may control the universal joint 50 to rotate in the opposite direction of the reaction force in each axial direction, so as to counteract the reaction force in respective axial direction. The main control unit 600 may obtain, based on the vibration signal of the photographing apparatus 100, a driving signal of the lens driving unit 233 or the image sensor driving unit 150, both are configured to perform the shake correction. The driving signal may indicate a driving amount of the motor that moves the lens 231 or the image sensor 120 along the X direction, and a driving amount of the motor that moves the lens 231 along the Y direction. The main control unit 600 may further obtain the driving signal indicating the vibration of the photographing apparatus 100 from the vibration sensor 250.

The main control unit 600 may control the universal joint 50 based on the vibration signal and the driving signal. The main control unit 600 may control, based on the vibration signal and the driving signal, and via the universal joint control unit 510, the universal joint 50 so as to maintain the preset attitude of the photographing apparatus 100. The main control unit 600 may determine, based on the driving signal, a first movement of the lens 231 or the image sensor 120 along the X direction. The first movement may be information indicating a thrust [in N (Newton)] generated by the movement of the lens 231 or the image sensor 120 in the X direction. The first movement may indicate the amount of movement that moves the lens 231 or the image sensor 120 in the X direction. The first movement may indicate a driving amount (torque) or the motor that moves the lens 231 or the image sensor 120 in the X direction, or a current value being input to the motor. The first movement may indicate the acceleration of the lens 231 or the image sensor 120 in the X direction.

The main control unit 600 may determine, based on the driving signal, a second movement of the lens 231 or the image sensor 120 along the Y direction. The second movement may be information indicating a thrust [in N (Newton)] generated by the movement of the lens 231 or the image sensor 120 in the Y direction. The second movement may indicate the amount of movement that moves the lens 231 or the image sensor 120 in the Y direction. The second movement may indicate a driving amount (torque) or the motor that moves the lens 231 or the image sensor 120 in the Y direction, or a current value being input to the motor. The second movement may indicate the acceleration of the lens 231 or the image sensor 120 in the Y direction.

The main control unit 600 may control a rotation of the photographing apparatus around a first axis, (e.g., the pitch axis), based on the first movement, and via the universal joint control unit 510 and the universal joint 50. The main control unit 600 may control a torque applied on the pitch axis, based on the first movement, and via the universal joint control unit 510 and the universal joint 50. The main control unit 600 may control a rotation of the photographing apparatus around a second axis, (e.g., the yaw axis), based on the second movement, and via the universal joint control unit 510 and the universal joint 50. The main control unit 600 may control a torque applied to the yaw axis, based on the second movement, and via the universal joint control unit 510 and the universal joint 50. The main control unit 600 may control a rotation of the photographing apparatus around a third axis, (e.g., the roll axis), based on the first movement and the second movement, and via the universal joint control unit 510 and the universal joint 50. The main control unit 600 may control a torque applied to the roll axis, based on the first movement and the second movement, and via the universal joint control unit 510 and the universal joint 50.

The main control unit 600 may control, based on the first movement and the second movement, and via the universal joint 50, a rotation of the photographing apparatus 100 centered around at least one of the pitch axis, the yaw axis, or the roll axis, to generate a counter force of at least one of the pitch axis, the yaw axis, or the roll axis against the reaction force of the pitch axis, the yaw axis and the roll axis of the universal joint 50, wherein the reaction force may be generated based on the movement of the lens 231 or the image sensor 120. The main control unit 600 may be a non-limiting example of a circuit.

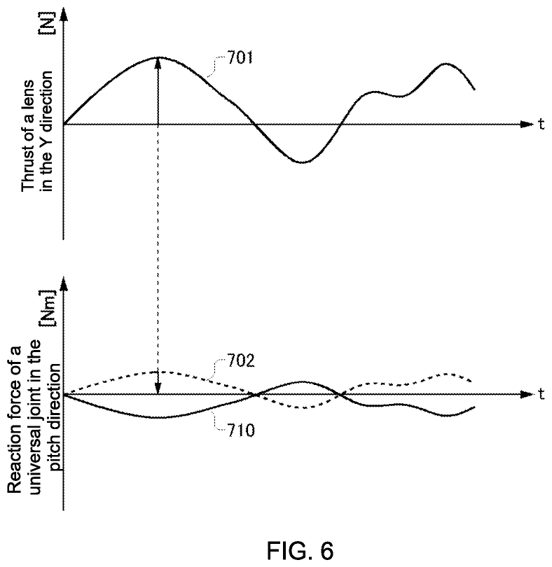

The main control unit 600 may determine/calculate a thrust 701 of the lens 231 in the Y direction as shown in FIG. 6, based on the driving signal of the lens driving unit 233 for performing image stabilization based on the vibration signal of the photographing apparatus 100. In addition, the main control unit 600 may determine/calculate a reaction force 702, applied to the pitch axis of the universal joint 50, against the thrust 701 of the lens 231 in the Y direction. The main control unit 600 may determine/calculate the driving amount of the photographing apparatus 100 centered around the pitch axis of the universal joint 50, so that a force 710 in the direction counteracting the reaction force 702 applied to the pitch axis of the universal joint 50 may be applied to the pitch axis of the universal joint 50. The main control unit 600 may determine/calculate a torque applied to the pitch axis of the universal joint 50, so that the force 710 in the direction counteracting the reaction force 702 applied to the pitch axis of the universal joint 50 may be applied to the pitch axis of the universal joint 50. Similarly, the main control unit 600 may determine/calculate the driving amount of the photographing apparatus 100 centered around the yaw axis of the universal joint 50, so that a force in the direction counteracting the reaction force 704 applied to the yaw axis of the universal joint 50 may be applied to the yaw axis of the universal joint 50. The main control unit 600 may determine/calculate a torque applied to the yaw axis of the universal joint 50, so that a force in the direction counteracting the reaction force 704 applied to the yaw axis of the universal joint 50 may be applied to the yaw axis of the universal joint 50.

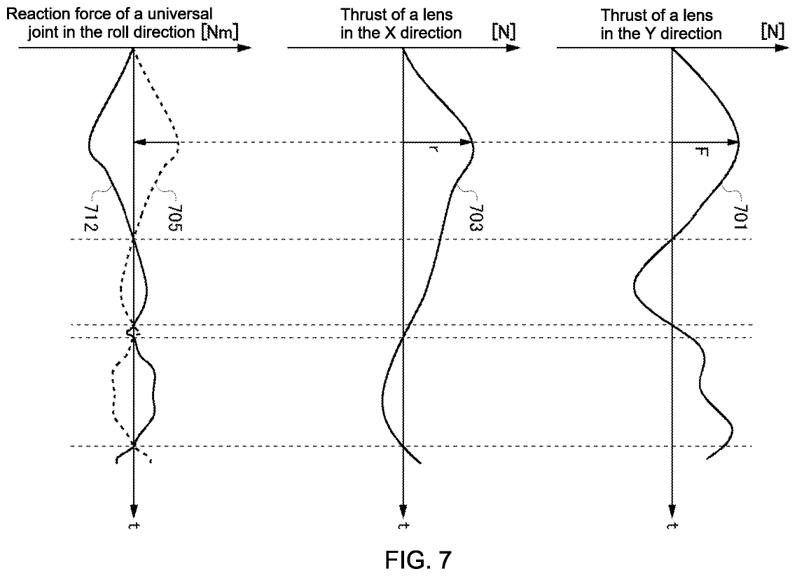

In addition, as shown in FIG. 7, the main control unit 600 may determine/calculate, based on the thrust 701 of the lens 231 in the Y direction and the thrust 703 of the lens in the X direction, a reaction force 705 applied to the roll axis of the universal joint 50. The main control unit 600 may determine/calculate the driving amount of the photographing apparatus 100 centered around the roll axis of the universal joint 50, so that a force in the direction counteracting the reaction force 705 applied to the roll axis of the universal joint 50 may be applied to the roll axis of the universal joint 50. The main control unit 600 may determine/calculate a torque applied to the roll axis of the universal joint 50, so that a force in the direction counteracting the reaction force 705 applied to the roll axis of the universal joint 50 is applied to the roll axis of the universal joint 50.

The universal joint control unit 510 may control, based on the determined/calculated driving amount of each axis, the yaw axis rotation assembly 516, the roll axis rotation assembly 526, and the roll axis rotation assembly 536. Therefore, the universal joint 50 may be prevented from being unable to appropriately control the attitude of the photographing apparatus 100 due to the reaction force applied to the universal joint 50 due to the movements of the lens 231 or the image sensor 120 while performing image stabilization.

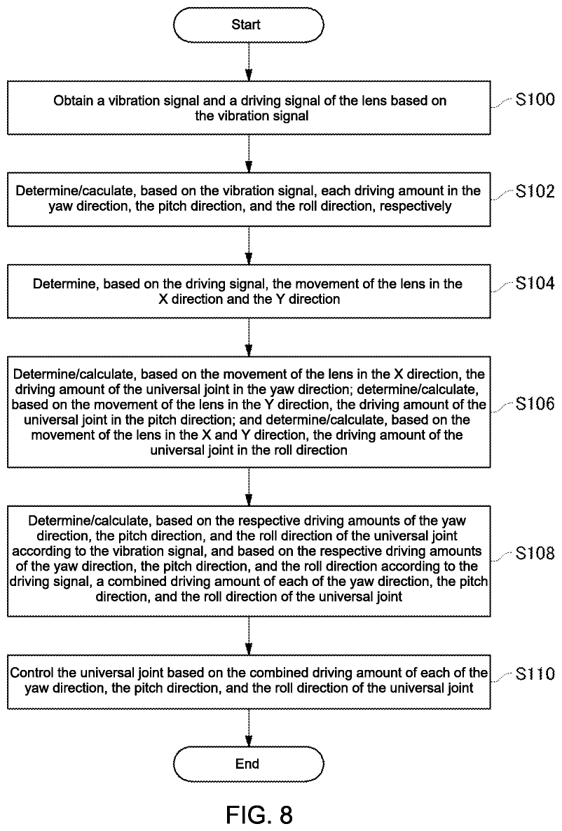

FIG. 8 is a flowchart illustrating a control procedure of a universal joint 50 when performing image stabilization according to some exemplary embodiments of the present disclosure.

The main control unit 600 may obtain, via the photographing control unit 110, a vibration signal indicating the vibration of the photographing apparatus 100 detected by the vibration sensor 250, and a driving signal of the lens 231 for performing image stabilization for the photographing apparatus 100 (S100). The main control unit 600 may determine/calculate, based on the vibration signal, each driving amount that controls the universal joint 50 in the yaw direction, the pitch direction, and the roll direction, respectively. (S102) The main control unit 600 may determine/calculate, based on the vibration signal, each driving amount of the universal joint 50 in the yaw direction, the pitch direction, and the roll direction, respectively, so as to maintain the preset attitude of the photographing apparatus 100.

In addition, the main control unit 600 may determine, based on the driving signal, the movement of the lens 231 in the X direction and the Y direction (S104). The main control unit 600 may determine, based on the driving signal, the thrust of the lens 231 in the X direction and the Y direction, to be the movement of the lens 231 in the X direction and the Y direction. The main control unit 600 may determine, based on the driving signal, the driving amount of each motor that moves the lens 231 in the X direction and the Y direction, respectively, to be the movement of the lens 231 in the X direction and the Y direction.

The main control unit 600 may determine/calculate, based on the movement of the lens 231 in the X direction, the driving amount of the universal joint 50 in the yaw direction. The main control unit 600 may determine/calculate, based on the movement of the lens 231 in the Y direction, the driving amount of the universal joint 50 in the pitch direction. The main control unit 600 may determine/calculate, based on the movement of the lens 231 in the X direction and the Y direction, the driving amount of the universal joint 50 in the roll direction. (S106).

The main control unit 600 may determine/calculate, based on the respective driving amounts of the yaw direction, the pitch direction, and the roll direction of the universal joint 50 according to the vibration signal, and based on the respective driving amounts of the yaw direction, the pitch direction, and the roll direction according to the driving signal, a combined driving amount of each of the yaw direction, the pitch direction, and the roll direction of the universal joint 50. (S108) The main control unit 600 may control, based on the combined driving amount of each of the yaw direction, the pitch direction, and the roll direction of the universal joint 50, the universal joint 50 to maintain the preset attitude of the photographing apparatus 100. (S110) The main control unit 600 may control, based on a feedback control according to the vibration signal and a feedforward control according to the driving signal, the universal joint 50 so that the photographing apparatus 100 may be in a desired attitude.

As described above, according to some exemplary embodiments of the present disclosure, a force is applied to each axis of the universal joint 50 in order to counteract the reaction force applied to each axis of the universal joint 50 due to the movement of the lens 231 or the image sensor 120 when performing image stabilization. Therefore, the universal joint 50 may be prevented from being unable to appropriately control the attitude of the photographing apparatus 100.

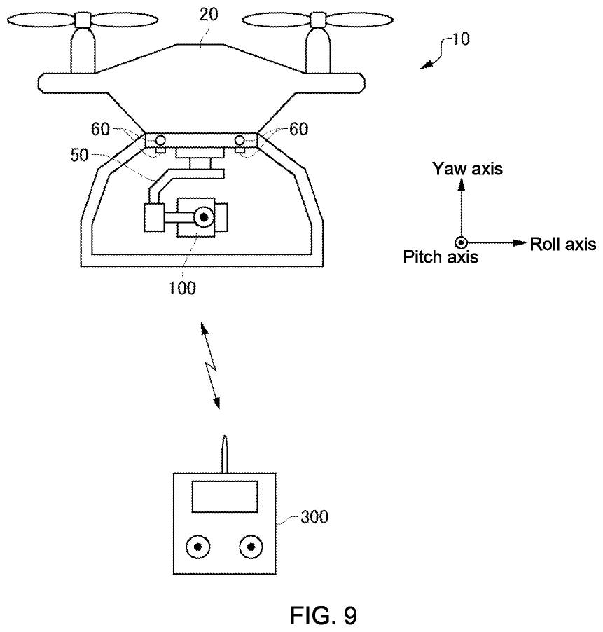

The foregoing photographing apparatus 100 may be mounted on a movable object. The photographing apparatus 100 may be mounted on an unmanned aerial vehicle (UAV) as shown in FIG. 9 according to some exemplary embodiments of the present disclosure. An UAV 10 may include an UAV main body 20, a universal joint 50, a plurality of photographing devices 60, and a photographing apparatus 100. The universal joint 50 and the photographing apparatus 100 together may be non-limiting examples of a photographing apparatus 100. The UAV 10 may be a non-limiting example of a movable object propelled by a propulsion unit. A non-limiting exemplary movable object may be a flying object such as an aircraft movable in the air, a vehicle movable on the ground, and a ship movable on the water, or the like, in addition to the UAV.

The UAV main body 20 may include a plurality of propellers. The plurality of propellers may be a non-limiting example of the propulsion unit. The UAV main body 20 may control the plurality of propellers to rotate to enable the UAV 10 to fly. The UAV main body 20 may use, for example, four propellers to enable the UAV 10 fly. A quantity of the propellers is not limited to four. Any number(s) of the propellers may be used. In addition, the UAV 10 may alternatively be a fixed-wing aircraft without any propellers.

The photographing apparatus 100 is an image camera for photographing an object included in a desired photographing range. The universal joint 50 may rotatably support the photographing apparatus 100. The universal joint 50 may be a non-limiting example of a supporting mechanism. In some exemplary embodiments according to the present disclosure, the universal joint 50 may use an actuator to rotatably support the photographing apparatus 100 to rotate around a pitch axis. The universal joint 50 may use the actuator to further rotatably support the photographing apparatus 100 to rotate around a roll axis and a yaw axis, respectively. The universal joint 50 may change the attitude of the photographing apparatus 100 by causing the photographing apparatus 100 to rotate around at least one of the yaw axis, the pitch axis, or the roll axis.

The plurality of photographing devices 60 may be sensing cameras that photograph the surroundings of the UAV 10 in order to control the flight of the UAV 10. For example, the UAV 10 may include four photographing devices 60. Two photographing devices 60 may be arranged on a nose of the UAV 10, that is, a front side of the UAV 10. In addition, the other two photographing devices 60 may be arranged on a bottom surface of the UAV 10. The two photographing devices 60 on the front side may be paired to function as a stereoscopic camera. The other two photographing devices 60 on the bottom surface may also be paired to function as a stereoscopic camera. Three-dimensional space data around the UAV 10 may be generated based on images photographed by the plurality of photographing devices 60. A quantity of the photographing devices included in the UAV 10 is not limited to four. Any quantity of the photographing devices 60 of the UAV 10 may be used. The UAV 10 may include at least one photographing device 60. Alternatively, the UAV 10 may include at least one photographing device 60 on each of the nose, a tail, a side surface, a bottom surface, and a top surface of the UAV 10, respectively. A viewing angle settable in the photographing device 60 may be greater than a viewing angle that may be set in the photographing apparatus 100. The photographing device 60 may also have a single focus lens or a fisheye lens.

A remote operation device 300 may communicate with the UAV 10 to remotely operate the UAV 10. The remote operation device 300 may wirelessly communicate with the UAV 10. The remote operation device 300 may transmit to the UAV 10 instruction information indicating various instructions related to the movement of the UAV 10 such as ascending, descending, accelerating, decelerating, moving forward, moving backward, and rotating. The non-limiting exemplary instruction information may include an instruction information causing the UAV 10 to ascend. The instruction information may indicate a height at which the UAV10 should be located. The UAV 10 may move to be located at the height indicated by the instruction information received from the remotely operated device 300. The instruction information may include an ascending instruction causing the UAV10 to ascend. The UAV 10 may ascend after receiving the ascending instruction. When the height of the UAV 10 has reached an upper height limit, ascending of the UAV 10 may be limited even if the ascending instruction is received.

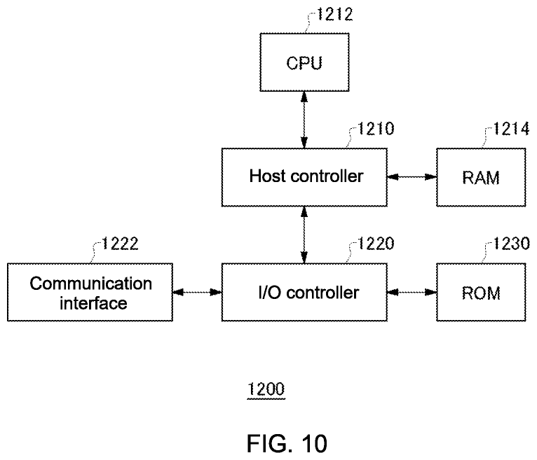

FIG. 10 is a diagram showing a computer 1200 that may reflect a plurality of manners of the present disclosure completely or partially according to some exemplary embodiments of the present disclosure. A program installed in the computer 1200 may enable it to function as an operation associated with the apparatus according to some exemplary embodiments of the present disclosure or one or more “units” of the apparatus. Alternatively, the program may enable the computer 1200 to execute the operation or the one or more “unit”. The program may enable the computer 1200 to execute the process or stages of the process involved in some exemplary embodiments of the present disclosure. The program may be executed by a CPU 1212, to enable the computer 1200 to execute specified operations associated with some or all the blocks in the flowcharts and the block diagrams described in the present disclosure.

The computer 1200 in some exemplary embodiments of the present disclosure may include the CPU 1212 and a RAM 1214, which may be interconnected through a host controller 1210. The computer 1200 may further include a communication interface 1222, an input/output unit, which may be connected to the host controller 1210 through the input/output controller 1220. The computer 1200 may further include a ROM 1230. The CPU 1212 may execute the program stored in the ROM 1230 and the RAM 1214 to control each unit.

The communication interface 1222 may communicate with other electronic devices via the network. A hard disk drive may store a program and a data used by the CPU 1212 in the computer 1200. The ROM 1230 may store a boot program or the like executable by the computer 1200 during operation, and/or a program that depend on a hardware of the computer 1200. The program is provided via a computer readable recording medium such as a CR-ROM, a USB memory, or an IC card, or a network. The program may be stored in the RAM 1214 or the ROM 1230 which is also a non-limiting example of the computer readable recording medium, and may be executed by the CPU 1212. The processing of the information written in the program may be read by the computer 1200 and may cause cooperation between the program and the various types of hardware resources described above. An information operation or processing may be implemented based on use of the computer 1200 to constitute an apparatus or a method.

For example, when the computer 1200 communicates with an external apparatus, the CPU 1212 may execute a communication program loaded in the RAM 1214, and may command, based on processing described in the communication program, the communications interface 1222 to perform communication processing. Under the control of the CPU 1212, the communications interface 1222 may read and send data stored in a send buffer provided in a recording medium such as the RAM 1214 or a USB memory, and may send the read sent data to a network, or may write received data received from the network into a receiving buffer provided by the recording medium, or the like.

In addition, the CPU 1212 may cause the RAM 1214 to read all or a necessary part of files or a database stored in an external recording medium such as a USB memory, and may execute various types of processing of the data on the RAM 1214. Then, the CPU 1212 may write the processed data back to the external recording medium.

Various types of information such as various types of programs, data, tables, and databases may be stored in the recording medium, for information processing. For data read from the RAM 1214, the CPU 1212 may perform various types of processing such as various types of operations specified by an instruction sequence of the program, information processing, conditional judgement, conditional transfer, unconditional transfer, and information retrieval/replacement, which may be described throughout the present disclosure, and write results back into the RAM 1214. In addition, the CPU 1212 may retrieve information from a file, a database, or the like within the recording medium. For example, when the recording medium stores a plurality of entries having an attribute value of a first attribute respectively associated with an attribute value of a second attribute, the CPU 1212 may retrieve, from the plurality of entries, an entry matching a condition of the attribute value of the first attribute, and may read the attribute value of the second attribute stored in the entry, thereby obtaining the attribute value of the second attribute associated with the first attribute meeting a preset condition.

The program or software module described above may be stored in the computer 1200 or on a computer readable recording medium near the computer 1200. In addition, a recording medium such as a hard disk or a RAM provided in a server system connected to a private communications network or the Internet may be used as a computer readable storage medium so that the program may be made available to the computer 1200 via the network.

The exemplary embodiments according to the present disclosure is described above by using the implementations. However, the technical scope of the exemplary embodiments according to the present disclosure is not limited to the scope described in the foregoing implementations. Evidently, a person of ordinary skill in the art may make various changes or improvements to the implementations. It is apparent from the description of the claims that all manners to which such changes or improvements are made may be included within the technical scope of the present disclosure.

It should be noted that the execution order of the actions, sequences, steps, and stages of the apparatuses, systems, programs, and methods in the claims, specification, and accompanying drawings of the specification may be implemented in any order, provided that there is no special statement such as “before . . . ” or “in advance”, and an output of previous processing is not used in subsequent processing. The operation procedures in the claims, specification, and accompanying drawings of the specification are described using “first” and “next” and the like are used for ease of description, but it does not mean that an implementation must be implemented in such an order.

What is claimed is:

1. A control apparatus for controlling a photographing system,
wherein the photographing system includes:
a photographing apparatus including an optical system, an image sensor, and a driving assembly, wherein when the photographing apparatus performs a shake correction, the driving assembly moves at least one of the optical system or the image sensor along a direction intersecting an optical axis of the optical system, and
a supporting assembly rotatably supporting the photographing apparatus,
the control apparatus comprising:
a circuit configured to:
obtain, based on a vibration signal indicating a vibration of the photographing apparatus, a driving signal of the driving assembly configured to perform the shake correction, and
control the supporting assembly based on the vibration signal and the driving signal.

2. The control apparatus according to claim 1, wherein the circuit is configured to:
control the supporting assembly based on the vibration signal and the driving signal, to maintain a preset attitude of the photographing apparatus.

3. The control apparatus according to claim 2, wherein
the supporting assembly supports the photographing apparatus to rotate around a first axis intersecting the optical axis, and
the circuit is configured to:
determine, based on the driving signal, a first movement of the at least one of the optical system or the image sensor along the direction of the first axis, and
control, based on the first movement and via the supporting assembly, a rotation of the photographing apparatus centered around the first axis.

4. The control apparatus according to claim 3, wherein
the supporting assembly supports the photographing apparatus to rotate around a second axis intersecting the optical axis and the first axis, and
the circuit is configured to:
determine, based on the driving signal, a second movement of the at least one of the optical system or the image sensor along the direction of the second axis, and
control, based on the second movement and via the supporting assembly, a rotation of the photographing apparatus centered around the second axis.

5. The control apparatus according to claim 4, wherein
the supporting assembly supports the photographing apparatus to rotate around a third axis along the optical axis, and
the circuit is configured to:
control, based on the first movement and the second movement, and via the supporting assembly, a rotation of the photographing apparatus centered around the third axis.

6. The control apparatus according to claim 5, wherein the circuit is configured to:
control, based on the first movement and the second movement, and via the supporting assembly, a rotation of the photographing apparatus centered around at least one of the first axis, the second axis, or the third axis, so as to generate a counter force of at least one of the first axis, the second axis, or the third axis against the reaction force of at least one of the first axis, the second axis, or the third axis of the supporting assembly,
wherein the reaction force is generated based on the movement of the at least one of the optical system or the image sensor.

7. The control apparatus according to claim 1, wherein the circuit is configured to:
control the driving assembly based on the driving signal.

8. A movable object, comprising:
a photographing system, including:
a photographing apparatus including:
an optical system, an image sensor, and a driving assembly, wherein when the photographing apparatus performs a shake correction, the driving assembly moves at least one of the optical system or the image sensor along a direction intersecting an optical axis of the optical system;
a supporting assembly rotatably supporting the photographing apparatus; and
a control apparatus to control the photographing system, including:
a circuit configured to:
obtain, based on a vibration signal indicating a vibration of the photographing apparatus, a driving signal of the driving assembly configured to perform the shake correction, and
control the supporting assembly based on the vibration signal and the driving signal.

9. The moveable object according to claim 8, wherein the movable object is an unmanned aerial vehicle.

10. The movable object according to claim 8, wherein
the supporting assembly supports the photographing apparatus to rotate around a first axis intersecting the optical axis, and
the circuit is configured to:
determine, based on the driving signal, a first movement of the at least one of the optical system or the image sensor along the direction of the first axis, and
control, based on the first movement and via the supporting assembly, a rotation of the photographing apparatus centered around the first axis.

11. The movable object according to claim 10, wherein
the supporting assembly supports the photographing apparatus to rotate around a second axis intersecting the optical axis and the first axis, and
the circuit is configured to:
determine, based on the driving signal, a second movement of the at least one of the optical system or the image sensor along the direction of the second axis, and
control, based on the second movement and via the supporting assembly, a rotation of the photographing apparatus centered around the second axis.

12. The movable object according to claim 11, wherein
the supporting assembly supports the photographing apparatus to rotate around a third axis along the optical axis, and
the circuit is configured to:
control, based on the first movement and the second movement, and via the supporting assembly, a rotation of the photographing apparatus centered around the third axis.

13. The movable object according to claim 12, wherein the circuit is configured to:
control, based on the first movement and the second movement, and via the supporting assembly, a rotation of the photographing apparatus centered around at least one of the first axis, the second axis, or the third axis, so as to generate a counter force of at least one of the first axis, the second axis, or the third axis against the reaction force of at least one of the first axis, the second axis, or the third axis of the supporting assembly,
wherein the reaction force is generated based on the movement of the at least one of the optical system or the image sensor.

14. A control method for controlling a photographing system,
wherein the photographing system includes:
a photographing apparatus including an optical system, an image sensor, and a driving assembly, wherein when the photographing apparatus performs a shake correction, the driving assembly moves at least one of the optical system or the image sensor along a direction intersecting an optical axis of the optical system, and
a supporting assembly rotatably supporting the photographing apparatus,
the control method comprising:
obtaining, based on a vibration signal indicating a vibration of the photographing apparatus, a driving signal of the driving assembly configured to perform the shake correction, and
controlling the supporting assembly based on the vibration signal and the driving signal.

15. The control method according to claim 14, comprising:
controlling the supporting assembly based on the vibration signal and the driving signal, to maintain a preset attitude of the photographing apparatus.

16. The control method according to claim 15, wherein the supporting assembly supports the photographing apparatus to rotate around a first axis intersecting the optical axis,
the control method comprising:
determining, based on the driving signal, a first movement of the at least one of the optical system or the image sensor along the direction of the first axis, and
controlling, based on the first movement and via the supporting assembly, a rotation of the photographing apparatus centered around the first axis.

17. The control method according to claim 16, wherein the supporting assembly supports the photographing apparatus to rotate around a second axis intersecting the optical axis and the first axis,
the control method comprising:
determining, based on the driving signal, a second movement of the at least one of the optical system or the image sensor along the direction of the second axis, and
controlling, based on the second movement and via the supporting assembly, a rotation of the photographing apparatus centered around the second axis.

18. The control method according to claim 17, wherein the supporting assembly supports the photographing apparatus to rotate around a third axis along the optical axis,
the control method comprising:
controlling, based on the first movement and the second movement, and via the supporting assembly, a rotation of the photographing apparatus centered around the third axis.

19. The control method according to claim 18, comprising:
controlling, based on the first movement and the second movement, and via the supporting assembly, a rotation of the photographing apparatus centered around at least one of the first axis, the second axis, or the third axis, so as to generate a counter force of at least one of the first axis, the second axis, or the third axis against the reaction force of at least one of the first axis, the second axis, or the third axis of the supporting assembly,
wherein the reaction force is generated based on the movement of the at least one of the optical system or the image sensor.

20. The control method according to claim 14, comprising:
controlling the driving assembly based on the driving signal.
